(19) United States
(12) Patent Application Publication
(10) Pub. No.: US 2010/0126362 A1
(43) Pub. Date: May 27, 2010

(54) BOTTOM-OF-THE-RANGE FRANKING MACHINE

(75) Inventor: Laurent FARLOTTI, Pruniers (FR)

Correspondence Address: SUGHRUE MION, PLLC, 2100 PENNSYLVANIA AVENUE, N.W., SUITE 800, WASHINGTON, DC, 20037, US

(73) Assignee: NEOPOST TECHNOLOGIES, Bagneux (FR)

(21) Appl. No.: 12/610,711

(22) Filed: Nov. 2, 2009

(30) Foreign Application Priority Data
Nov. 7, 2008 (FR) 0857598

(51) Int. Cl. B41L 47/46

(52) U.S. Cl. 101/91

(57) ABSTRACT

In a franking machine for printing a postal imprint on a mailpiece, which machine is provided with feed slot for feeding the mailpiece into the machine and with a print head for printing said postal imprint line-by-line while the mailpiece is moving under the print head, synchronization means are also provided for acting so that the command to print said postal imprint is synchronized with manual removal of said mailpiece from the machine by an operator.

### FIELD OF THE INVENTION

The present invention relates to the field of mail handling. It relates more particularly to a franking machine or “postage meter” that is of simple design and of low cost, and that is designed to be used for franking small numbers of mailpieces.

### PRIOR ART

In Patent FR 2 896 447, the Applicant has already proposed such a franking machine in which the mailpiece-receiving deck is inclined in two directions so as to avoid the need to use motor-driven means for conveying the mailpieces. However, that machine suffers from drawbacks because, in practice, it does not enable the mailpieces to be sized automatically, and, above all, its stationary print head does not make it possible to guarantee printing quality that is identical for all of the mailpieces since the distance between that print head and the top surface of the mailpiece varies depending on mailpiece thickness.

### OBJECT AND DEFINITION OF THE INVENTION

An object of the present invention is to provide a franking machine that mitigates the above-mentioned drawbacks and thus that has a cost that is even lower while preserving the small size, the robustness, and the simplicity of use of the prior art machine. Another object of the invention is to propose a franking machine making it possible to determine the price category for the mailpiece without it being necessary to incorporate a weigh module.

These objects are achieved with a franking machine for printing a postal imprint on a mailpiece, which machine is provided with feed slot for feeding the mailpiece into the machine and with a print head for printing said postal imprint line-by-line while said mailpiece is moving under said print head, wherein said franking machine is further provided with synchronization means for acting so that the command to print said postal imprint is synchronized with manual removal of said mailpiece from the machine by an operator.

Thus, mere removal of the mailpiece from the machine by the operator suffices to actuate the synchronization means necessary for printing the postal imprint line-by-line.

Preferably, said synchronization means comprise a movement sensor for acquiring successive positions of the mailpiece while said manual removal is taking place.

Depending on the embodiment, said movement sensor comprises an encoder wheel in contact with a top surface of said mailpiece and whose movement in rotation is proportional to the movement of said mailpiece in said feed slot while said manual removal is taking place, or said movement sensor comprises a contactless optical sensor disposed facing a top surface of the mailpiece.

Preferably, said franking machine is also provided with a retractable protective cover for protecting said print head and with synchronized movement means for automatically retracting said retractable protective cover as said mailpiece is fed into the machine, for holding said retractable cover away while said mailpiece is being manually removed, and for putting said retractable protective cover back in place once said manual removal is complete.

Said retractable protective cover is hinged to the end of a retractor arm that is mounted to pivot about a pin under the effect of said mailpiece advancing into said feed slot, and said retractor arm is terminated at its free end by a finger designed to co-operate with a contact surface of a holding trigger that is caused to pivot about a pin in opposition to thrust resilient means by a flexible link having one end fastened to that end of said holding trigger that is opposite from said contact surface and having its other end secured to an actuator wheel in contact with said mailpiece.

In a preferred embodiment, the machine is further provided with a holding plate hinged about a pivot pin secured to the structure and acting in opposition to resilient return means to press said mailpiece against a top face of said feed slot, in order to guarantee that the distance between a top surface of said mailpiece and said print head is identical regardless of the thickness of said mailpiece.

Advantageously, said plate is provided with a perpendicular masking flange designed to co-operate with a set of sensors mounted in the structure for determining the thickness of said mailpiece by means of various predetermined thresholds being crossed.

Preferably, said feed slot is open on two mutually perpendicularly ones of the sides of said structure and defines two referencing walls respectively for the top longitudinal side and for the front transverse side of said mailpiece in order to bring said mailpiece into abutment at its top right corner.

Advantageously, the machine of the invention is also provided with a first sensor disposed where said longitudinal and transverse referencing walls of said feed slot meet and for checking that said mailpiece is correctly positioned as fully inserted into said feed slot, it is further provided with at least one first series of sensors disposed on the same line parallel to said transverse referencing wall and at predetermined distances from said longitudinal referencing wall so as to define different predetermined width thresholds for said mailpiece, and it is further provided with at least one second series of sensors disposed on the same line under said feed slot so as to define different predetermined thickness thresholds for said mailpiece.

Preferably, removable memory means are also provided that contain both graphical data making it possible to print said postal imprint and franking accounting data comprising up-counters and down-counters in particular for making it possible for the machine to be used in self-service mode.

The invention also provides a method of printing a postal imprint on a mailpiece, wherein a command to print said postal imprint is synchronized by said mailpiece being removed manually by an operator from a referencing position where it is fully inserted in a feed slot of a franking machine.

Advantageously, in said in said referencing position, the category of mail to which said mailpiece belongs is determined by whether a plurality of width and/or thickness sensors are masked or unmasked.

### BRIEF DESCRIPTION OF THE DRAWINGS

The characteristics and advantages of the present invention appear more clearly from the following description, given by way of non-limiting indication, and with reference to the accompanying drawings, in which:

FIGS. 1 to 3 are schematic diagrams that show the franking machine of the invention and in three successive positions; and

FIGS. 4 and 4A are two plan views at the mailpiece feed slot of the machine in FIG. 1 for two different types of sensor.

### DETAILED DESCRIPTION OF A PREFERRED EMBODIMENT

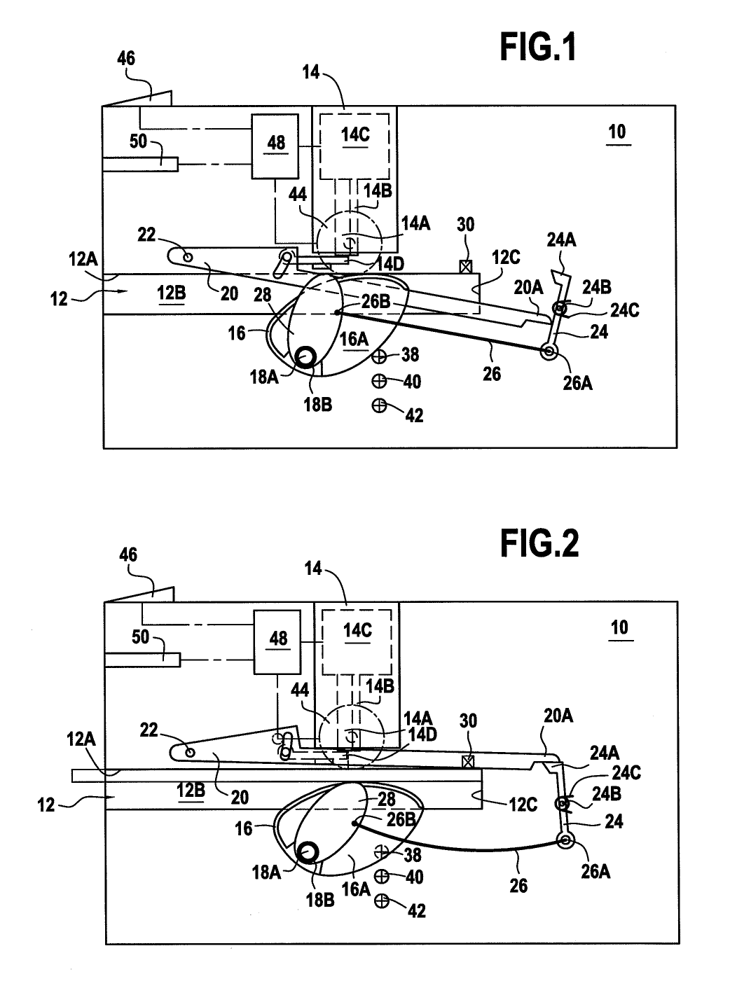

FIGS. 1 to 4 are schematic diagrams of a mailpiece franking machine of the invention. The mailpieces are of standardized common formats, and each of them is designed to receive a postal imprint that is printed, as is customary, in the top right corner of the mailpiece.

In a structure 10 that is substantially in the shape of a rectangular block, this novel franking machine includes: a feed slot 12 for receiving a mailpiece; print means for printing on the mailpiece, which print means are typically constituted by an ink jet print head 14 formed by at least one row (e.g. two rows 14A, 14B) of ink ejection nozzles and by a disposable ink cartridge 14C for feeding said ink nozzles; and a plurality of preferably optical sensors for determining the format of the mailpiece fed into the franking machine or indeed for determining movement of the mailpiece. In order to guarantee a print distance (distance between the top surface of the mailpieces and the ink ejection nozzles) that is identical regardless of thickness of the mailpiece, said mailpiece is pressed against the top face 12A of the feed slot (principle of top referencing) by a holding pate 16 hinged about a pivot pin 18A secured to the structure and acting in opposition to resilient return means 18B advantageously disposed around said pin. Said plate is advantageously provided with a perpendicular masking fin or flange 16A designed to co-operate with a set of preferably optical sensors mounted in the structure to determine the thickness of the mailpiece by means of various predetermined thresholds being crossed.

The feed slot 12 for feeding a mailpiece into the machine has a height corresponding to the maximum thickness of the mailpieces that can be processed by the machine, which thickness is typically 20 millimeters (mm), and said feed slot is open on two of the perpendicular sides of the structure that, by defining two referencing walls 12B, 12C for respective ones of the top longitudinal and front transverse sides of the mailpiece, makes it possible to bring the mailpiece into abutment at its top right corner.

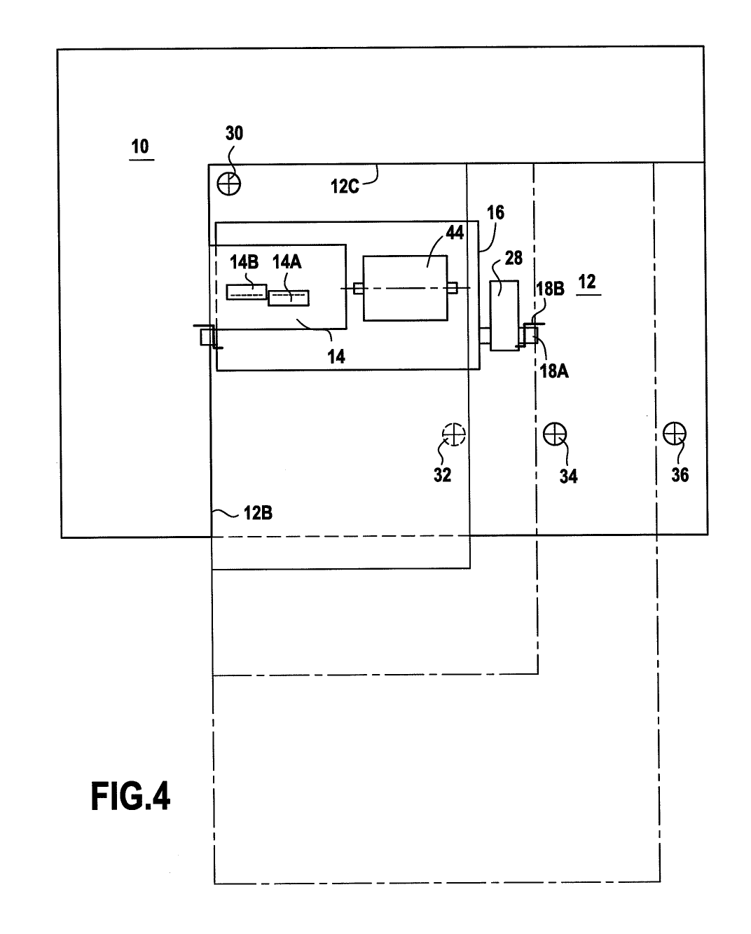

The print head 14 can have one (see FIG. 4A) or two rows of ink ejection nozzles protected by a retractable protective cover 14D designed to avoid the nozzles being obstructed by dry ink while they are not in use. Said cover is moved automatically, in such manner as to be synchronized with the movement of the mailpiece, both when it is fed in and when it is removed, via synchronized movement means having a suitable linkage. More particularly, the retractable protective cover is hinged to the end of a retractor arm 20 that can pivot about a pin 22 under the effect of the mailpiece advancing into the feed slot. Said retractor arm is terminated at its free end by a finger 20A designed to co-operate with a contact surface 24A of a holding trigger 24 that is caused to pivot about a pin 24B in opposition to a resilient element 24C by a flexible link 26 having one end 26A fastened to that end of the holding trigger that is opposite from the contact surface, and having its other end 26B secured to a wheel 28 mounted, like the plate 16, on the pin 18A, and acting like said plate to press the mailpiece against the top surface of the slot 12.

Two series of optical sensors disposed at different places in the structure make it possible firstly to detect different mailpiece widths (to which particular lengths correspond due to mailpieces being standardized) and secondly, as explained above, to detect the thickness of the mailpiece. More particularly, a first sensor 30, disposed at the inside corner of the feed slot 12 where the longitudinal and transverse referencing walls meet, makes it possible to verify that the mailpiece is positioned correctly such that it is fully inserted into the feed slot, and in particular that its top right corner is properly in contact with the inside corner of the feed slot. A first series of sensors such as second, third, and fourth sensors 32, 34, and 36 are disposed along a common line that is parallel to the transverse referencing wall 12C at distances from the longitudinal referencing wall 12B of the slot that are predetermined (and that depend on the applicable postal regulations), so as to define different predetermined width thresholds for the mailpiece. For example, for a machine designed for the American market, said sensors are advantageously positioned at 89 mm, 108 mm, and 155 mm. For another market, these positions are naturally different. It is also possible to have a “universal” configuration that could be used on various different markets, only the sensors that are relevant to a given market then being activated during manufacture of the machines or during distribution of them on that market. A second series of sensors, e.g. fifth, sixth, and seventh sensors 38, 40, and 42 are also disposed along a common line under the surface of the slot so as to act by being masked to define various predetermined thickness thresholds for the mailpiece. For example, for a machine designed for the American market, these sensors are advantageously positioned at 0.4 mm, 6.4 mm, and 19.1 mm. Naturally, for some other market, these positions are different. It is, however, possible to make provision for a configuration with a plurality of individual sensors that could be used on various different markets, only the sensors that are relevant to a given market then being activated during manufacture of the machines or during distribution of them on that market. It is also possible to make provision for an even more universal configuration simply with a strip of sensors that then make it possible to measure thickness continuously.

Finally, a movement last sensor 44 is provided for synchronizing the command to print the postal imprint with the movement of the mailpiece in the feed slot. This sensor can be of the mechanical type and be constituted, for example, by an encoder wheel in contact with the top surface of the mailpiece, the movement in rotation of the wheel being proportional to the linear movement of the mailpiece and making this synchronization possible, as is known. This sensor 44A can also, as is shown in FIG. 4A, be contactless and of the optical type, and by being disposed facing the top surface of the mailpiece, acquire successive positions of the mailpiece so as to deliver synchronization pulses for printing the postal imprint. Such a sensor is described, for example, in U.S. Pat. No. 5,495,103 assigned to the Applicant.

The machine further includes a simplified user interface 46 merely for inputting the postal data necessary for determination purposes (for determining the destination geographical zone and the services requested), and secure processor means 48 connected to the various sensors, to the user interface, and to the print head so as to control printing of the postal imprint. Preferably, the machine also includes removable memory means 50 of the memory card type containing graphical data making it possible to print the postal imprint and optionally franking accounting data comprising up-counters and down-counters in particular for making it possible, for example, for the machine to be used in self-service mode. In an alternative embodiment, these removable means can be fastened to the structure and can then be accompanied by connection means for connection to a remote server, so as then to make the franking machine a communicating machine, in particular for re-purchasing credit and for sending postal data.

Operation of the machine is explained in more detail below with reference to FIGS. 1 to 3.

FIG. 1 shows the rest position of the machine, in which position no mailpiece has yet been fed in. Under the action of the return means 18B, the plate 16 bears against the top reference surface 12A of the feed slot, and none of the width and thickness sensors are masked. The movement sensor 44 is inoperative and the print head 14 is protected by its protective cover 14D.

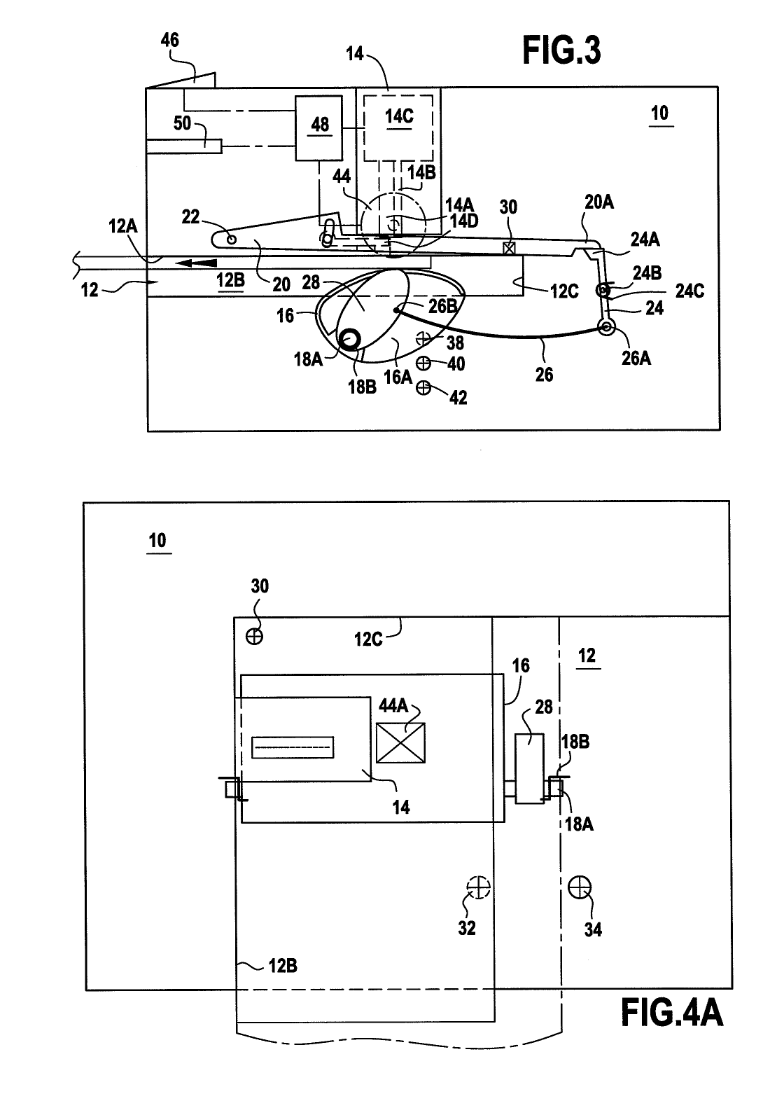

FIG. 2 shows a second position in which a mailpiece having a determined format has been fed into the machine and is in abutment, being fully inserted into the feed slot 12. In this abutment position (referencing position), the mailpiece has gone past the movement sensor for a first time but without that generating any particularly synchronization action at the processor means. Conversely, the mailpiece advancing causes the retractor arm 20 to be raised into a horizontal position in which the finger 20A comes to be placed on the contact surface 24A of the holding trigger 24, and remains thereon under the pressure from the thrust spring 24C, the arm being raised in this way, and by pivoting about the pin 22, also actuates retraction of the protective cover 14D, thereby unmasking the ink ejection nozzles. In parallel, a plurality of the optical sensors of the machine are masked as the mailpiece is fed in. Firstly, for example, the sensor 32 is masked if the mailpiece has a width less than 108 mm but greater than 89 mm, and then the sensor 38 is masked if the flange 16A of the plate 16 that moves under the effect of the mailpiece advancing has come to mask this sensor, and finally the sensor 30 is masked because the mailpiece is in abutment as fully inserted into the feed slot 12. In this abutment position, the franking amount is computed on the basis of the status data delivered by the optical sensors. Subject to having input, on the user interface, the requested service (e.g. first class mail) and optionally the destination zone of the mailpiece (post code or ZIP code), it is possible for the secure processor means 48 to which said sensors are connected to determine, on the basis of an indication of the format of the mailpiece (width with which a length and a thickness are associated), the price category to which the mailpiece belongs and thus the franking amount to which it should be subjected. Whereupon, the franking can be launched and the availability of the machine for this operation can be indicated to the operator at its user interface or by any other suitable means, such as a sound or light indicator (not shown). This signal informs the operator that the mailpiece can be removed from the machine, as shown in FIG. 3 that shows an intermediate removal position.

In this position, it can be noted that the back optical sensor 30 is unmasked but that the other optical sensors are not yet unmasked, and that the protective cover 14D is still retracted because the retractor arm 20 is held in its preceding position by the holding trigger 24 whose contact surface 24A supports the finger 20A of the retractor arm. During this removal stage, the movement sensor 44 successively acquires the various positions of the mailpiece, thereby, and conventionally this time, synchronizing printing of the postal imprint, and doing so independently of the speed at which the mailpiece is removed, i.e. regardless of whether or not it is removed quickly (if the removal is stopped, printing is stopped). When, while it is being removed, the mailpiece goes past the print head 14, the actuator wheel 28 returns to its original position and, by pulling on the trigger-actuating flexible link 26 disengages the finger 20A from the contact surface 24A, thereby releasing the retractor arm 20 again, and thereby bringing the protective cover 14D back into its rest position in which the ink ejection nozzles are protected again as shown in FIG. 1.

Thus, with the present invention, synchronized motor-driven means no longer exist, and it is the operator, by removing the mailpiece from the machine, who actuates the process of printing the postal imprint. This results in a franking machine that is of simpler design and of higher reliability due to the absence of moving mechanical parts.

The franking machine of the present invention is particularly well suited to franking small numbers of mailpieces (at the most a few tens per day) and, by means of its simplified and robust structure, it can be implemented in a variety of environments, not only office automation environments, but also industrial or commercial environments.

What is claimed is:

1. A franking machine for printing a postal imprint on a mailpiece, which machine is provided with feed slot for feeding the mailpiece into the machine and with a print head for printing said postal imprint line-by-line while said mailpiece is moving under said print head, wherein said franking machine is further provided with synchronization means acting so that the command to print said postal imprint is synchronized with manual removal of said mailpiece from the machine by an operator.

2. A franking machine according to claim 1, wherein said synchronization means comprise a movement sensor for acquiring successive positions of the mailpiece while said manual removal is taking place.

3. A franking machine according to claim 2, wherein said movement sensor comprises an encoder wheel in contact with a top surface of said mailpiece and whose movement in rotation is proportional to the movement of said mailpiece in said feed slot while said manual removal is taking place.

4. A franking machine according to claim 2, wherein said movement sensor comprises a contactless optical sensor disposed facing a top surface of the mailpiece.

5. A franking machine according to claim 1, that is also provided with a retractable protective cover for protecting said print head and with synchronized movement means for automatically retracting said retractable protective cover as said mailpiece is fed into the machine, for holding said retractable cover away while said mailpiece is being manually removed, and for putting said retractable protective cover back in place once said manual removal is complete.

6. A franking machine according to claim 5, wherein said retractable protective cover is hinged to the end of a retractor arm that is mounted to pivot about a pin under the effect of said mailpiece advancing into said feed slot.

7. A franking machine according to claim 6, wherein said retractor arm is terminated at its free end by a finger designed to co-operate with a contact surface of a holding trigger that is caused to pivot about a pin in opposition to resilient means by a flexible link having one end fastened to that end of said holding trigger that is opposite from said contact surface and having its other end secured to an actuator wheel in contact with said mailpiece.

8. A franking machine according to claim 1, that is further provided with a holding plate hinged about a pivot pin secured to the structure and acting in opposition to resilient return means to press said mailpiece against a top face of said feed slot, in order to guarantee that the distance between a top surface of said mailpiece and said print head is identical regardless of the thickness of said mailpiece.

9. A franking machine according to claim 8, wherein said plate is provided with a perpendicular masking flange designed to co-operate with a set of sensors mounted in the structure for determining the thickness of said mailpiece by means of various predetermined thresholds being crossed.

10. A franking machine according to claim 1, wherein said feed slot is open on two mutually perpendicularly ones of the sides of said structure and defines two referencing walls respectively for the top longitudinal side and for the front transverse side of said mailpiece in order to bring said mailpiece into abutment at its top right corner.

11. A franking machine according to claim 10, that is also provided with a first sensor disposed where said longitudinal and transverse referencing walls of said feed slot meet and for checking that said mailpiece is correctly positioned as fully inserted into said feed slot.

12. A franking machine according to claim 10, that is further provided with at least one first series of sensors disposed on the same line parallel to said transverse referencing wall and at predetermined distances from said longitudinal referencing wall so as to define different predetermined width thresholds for said mailpiece.

13. A franking machine according to claim 10, that is further provided with at least one second series of sensors disposed on the same line under said feed slot so as to define different predetermined thickness thresholds for said mailpiece.

14. A franking machine according to claim 1, that is further provided with removable memory means containing both graphical data making it possible to print said postal imprint and franking accounting data comprising up-counters and down-counters in particular for making it possible for the machine to be used in self-service mode.

15. A method of printing a postal imprint on a mailpiece, wherein a command to print said postal imprint is synchronized by said mailpiece being removed manually by an operator from a referencing position where it is fully inserted in a feed slot of a franking machine.

16. A method according to claim 15, wherein, in said referencing position, the category of mail to which said mailpiece belongs is determined by whether a plurality of width and/or thickness sensors are masked or unmasked.
